(19) United States
(12) Patent Application Publication
(10) Pub. No.: US 2010/0071795 A1
(43) Pub. Date: Mar. 25, 2010

(54) FLEXIBLE HOSES HAVING A KINK, CRUSH, AND BURST RESISTANT CONSTRUCTION

(75) Inventors: Anthony Montalvo, Medina, OH (US); Robert H. Vogliano, Tallmadge, OH (US)

Correspondence Address: Alvin T. Rockhill, P.O. Box 1283, Bath, OH, 44210, US

(73) Assignee: VEYANCE TECHNOLOGIES, INC., Fairlawn, OH (US)

(21) Appl. No.: 12/235,212

(22) Filed: Sep. 22, 2008

(51) Int. Cl. F16L 11/00

(52) U.S. Cl. 138/126; 138/132

(57) ABSTRACT

A flexible hose construction with enhanced levels of kink, crush, and burst resistance. The hose includes an inner tubular member, an outer tubular member, a yarn layer disposed between the inner and outer tubular members, and a plurality of reinforcement strips within the outer tubular member. The reinforcement strips are helically wound with a given pitch about the lumen of the tubular member. The outer tubular member is composed of a first compound containing an olefin block copolymer and a styrene/ethylene-butylene/styrene-based thermoplastic elastomer. The reinforcement strips are composed of a second compound containing a thermoplastic elastomer and a polypropylene homopolymer.

### BACKGROUND

The invention relates generally to flexible hoses and, more particularly, to flexible hoses having a construction that is kink, crush, and burst resistant.

Conventional flexible hoses have been manufactured for many years, first out of natural rubber and more recently out of petrochemical derivatives such as synthetic rubber, thermoplastic rubbers, or polymers. “Kinking” is a phenomenon that may occur when the hose is doubled over or twisted. When kinking occurs, fluid flow through the hose can be either severely restricted or blocked. Kinking is a nuisance that causes the user to waste time unkinking the hose. Extreme kinking may occur when, for example, a newly purchased coiled garden hose is initially used. At the time of initial use, a coupling at one end of the hose is fastened to a faucet. The user typically grasps the opposite end of the hose and moves away from the faucet without allowing the coiled hose to untwist. Kinking also occurs after the initial use as a consequence of routine movements by the user.

When a hose kinks, water flow through the hose is blocked. The user must then attempt to remove the blockage by manual manipulation, such as by swinging the hose to relax the kink or approaching the kinked location and manually straightening the kink. Certain kinks may require the user to return to the faucet, shut off the flow at the faucet to release the fluid pressure in the hose, and then manually unkink the hose. The user suffers further inconvenience because he or she must walk back, reestablish the flow of water through the hose, and then return to the opposite end of the hose to continue use. An even more acute problem arises when the user has already attached a large sprinkler device, such as an oscillating sprinkler to the end, and is forced to untwist the hose with this device attached.

The tendency of flexible hoses to kink may be at least partially alleviated by winding a helical wrap about the exterior of the inner tubular conduit. However, because of the choice of construction materials for the wrap and conduit, such kink resistant hoses achieve enhanced flexibility by sacrificing crush resistance to an externally applied force. When these reinforced hoses are deformed, for example by walking on or driving over them with a car, the helical wrap tends to permanently deform. The permanent deformation restricts the fluid path. Another approach for increasing the kink resistance of flexible hoses is to increase the wall thickness of the tubular conduit. However, increasing the wall thickness sacrifices hose flexibility such that these hoses are more cumbersome for a user to handle and manipulate. Increasing the wall thickness also makes the hose heavier.

Thus, an improved hose construction is desired that is characterized by a suitable physical property combination of kink resistance, crush resistance, and burst resistance.

### SUMMARY

The invention provides for a hose construction that is concurrently kink, crush, and burst resistant to an extent unachievable by conventional hose designs. The hose includes an inner tubular member, an outer tubular member, a yarn layer disposed between the inner and outer tubular members, and a plurality of reinforcement strips within the outer tubular member. The reinforcement strips are helically wound with a pitch about the lumen of the tubular member. The outer tubular member is composed of a first compound containing an olefin block copolymer and a styrene/ethylene-butylene/styrene-based thermoplastic elastomer. The reinforcement strips are composed of a second compound containing a thermoplastic elastomer and a polypropylene homopolymer. The hose may be suitable for various different household and industrial applications.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a perspective view of a hose constructed in accordance with an embodiment of the invention.

FIG. 2 is an enlarged perspective view of a portion of the hose of FIG. 1 in which the layers are partially removed for purposes of description.

FIG. 3 is a cross-sectional view taken along a vertical section of FIG. 2.

### DETAILED DESCRIPTION

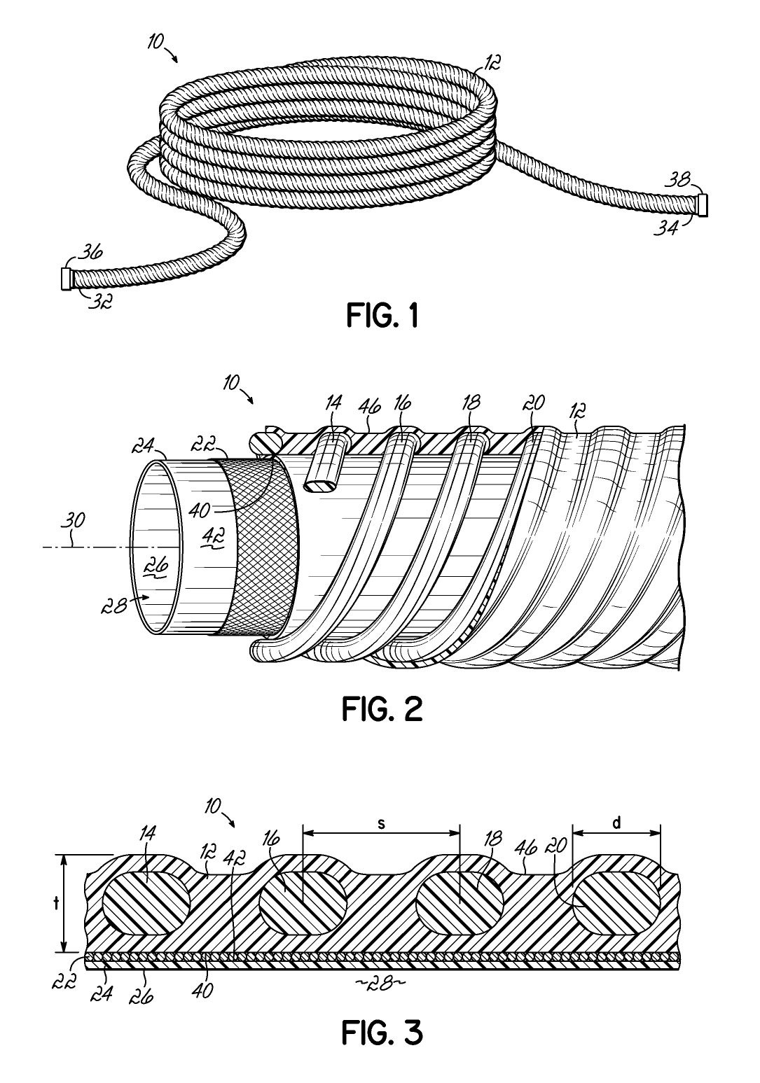

With reference to FIGS. 1-3, a kink, crush, and burst resistant hose 10 includes a tubular member in the form of an outer cover 12, a plurality of reinforcement strips 14, 16, 18, 20 embedded in the outer cover 12, a yarn layer 22, and an inner tubular member 24. The inner tubular member 24 has an inner surface 26 concentrically arranged about an open channel or lumen 28 extending along the length of the hose 10. The reinforcement strips 14, 16, 18, 20 are wound about a longitudinal axis 30 that is diametrically centered within the lumen 28. The hose 10 extends axially for an indefinite length along the central longitudinal axis 30 and has a length that may vary depending upon the intended use. Opposite ends 32, 34 of the flexible hose 10 are terminated by conventional hose fittings 36, 38, respectively, used for coupling the flexible hose 10 to a complementary hose fittings (not shown) of a fluid source, a fluid drain, a fluid dispenser, or even another flexible or rigid hose or conduit.

The outer cover 12 has an inner surface 40 and the yarn layer 22 and inner tubular member 24 are disposed radially, relative to the longitudinal axis 30, inside of the inner surface 40. The yarn layer 22 is disposed radially, relative to the longitudinal axis 30, between the inner surface 40 of the outer cover 12 and an outer surface 42 of the inner tubular member 24. The inner surface 26 of the inner tubular member 24, which borders and defines the open lumen 28, is exposed to the fluid conveyed through the lumen 28 and is typically substantially smooth. The inner surface 26 of the inner tubular member 24 may have an inner diameter of, for example, ¼″, ⅜″, ½″, ⅝″, ¾″, or 1″ as dictated by the intended hose design. The outer cover 12, the yarn layer 22, and the inner tubular member 24 are approximately symmetrical about the longitudinal axis 30.

The outer cover 12 includes an annular sidewall with an inner and outer diameter separated by a wall thickness, t, between the inner surface 40 and an outer surface 46. Because of the presence of the reinforcement strips 14, 16, 18, 20 at least partially embedded within the sidewall of the outer cover 12, the wall thickness, t, may vary along the axial length of the hose 10. The variation is reflected in the periodic bump in the outer surface 46 apparent at the locations of the reinforcement strips 14, 16, 18, 20. The outer surface 46 of the outer cover 12 is exposed to the working environment of the hose 10.

The yarn layer 22 may comprise a braided fabric of filaments as shown in FIG. 2, or a knit fabric, a spiral or continuous filament helically wound about the inner tubular member 24. The filaments of the yarn layer 22 may be composed of any suitable material, such as polyester, polypropylene, nylon, rayon, aramid, carbon fiber, polyvinyl alcohol (PVA), poly p-phenylene-2,6-bezobisoxazole (PBO), or ceramic fibers such as silicon carbide, as understood by a person having ordinary skill in the art, and may have the form of a monofilament or a multi-filament material. In one embodiment, the filaments of the yarn layer 22 may be wrapped in a 9×9 pattern in which nine filaments are wrapped in one direction and nine filaments are wrapped in an opposite direction.

Each of the reinforcement strips 14, 16, 18, 20 includes a plurality of continuous coils or turns, that are wound with a spiral or helical winding pattern having a helical pitch measured along the central longitudinal axis 30 such that adjacent turns of the different strips 14, 16, 18, 20 are non-contacting and, thereby, separated or spaced apart from each other by a center-to-center or centerline spacing, s. The pitches for the reinforcement strips 14, 16, 18, 20 are approximately equal. The centerline spacing, s, between adjacent pairs of the reinforcement strips 14, 16, 18, 20 may range from about 50 percent of the diameter, d, of the individual turns to about 500 percent of the diameter, d. In a specific embodiment, the centerline spacing, s, for adjacent pairs of the reinforcement strips 14, 16, 18, 20 may be about 100 percent of the diameter, d. The turns of the reinforcement strips 14, 16, 18, 20 may have a geometrical shape with a round cross section as depicted in FIGS. 2 and 3, an oval cross section, a hexagonal cross section, or another suitable cross section. The axial gaps between adjacent turns of the reinforcement strips 14, 16, 18, 20 are filled by the material of the outer cover 12. In an alternative embodiment, the hose 10 may include more or less than four reinforcements strips 14, 16, 18, 20 so long as multiple strips are present.

The cross-sectional area of the reinforcement strips 14, 16, 18, 20, as well as the helical pitch of the reinforcement strips 14, 16, 18, 20, may influence the flexibility of the hose 10 and its strength against flattening and against pressure to resist bursting. Increasing the helical pitch of the reinforcement strips 14, 16, 18, 20 in the axial direction increases the centerline spacing, s, which reduces the flexibility of the hose, and may decrease the strength against flattening and pressure resistance against bursting. Increasing the cross-sectional area of the reinforcement strips 14, 16, 18, 20 increases the crush resistance against flattening but may reduce the flexibility.

In one aspect, the reinforcement strips 14, 16, 18, 20 comprise a high modulus material having a greater initial modulus than a low modulus material forming the outer cover 12. Because of the higher initial modulus, the high modulus material forming the reinforcement strips 14, 16, 18, 20 have a greater rigidity (or lower flexibility) than the low modulus material forming the outer cover 12. As understood by a person having ordinary skill in the art, the initial modulus is a physical property of a material measured from the slope of an engineering stress-strain curve at low strain levels near zero strain. An engineering stress-strain curve is a graph representing an experimental measurement derived from measuring load (i.e., stress) versus extension (i.e., strain) for a sample of a material. The shape and characteristics of the stress-strain curve vary with the type of material. The stress-strain curve features an initial elastic region over an initial range of relatively low applied stresses, followed by a plastic region over another range of moderate applied stresses, and ultimately fracture at a sufficiently high applied stress.

The high modulus material of reinforcement strips 14, 16, 18, 20 may be composed primarily of a rigid thermoplastic elastomer (TPE), which is often referred to as a thermoplastic olefin (TPO). The high modulus material is selected imparts high burst strength, good crush resistance/resilience, and kink resistance to the hose 10. In various embodiments, the high modulus material of reinforcement strips 14, 16, 18, 20 may comprise a compound of a TPE and polypropylene having a composition ranging from about 80 percent by weight (wt. %) TPE to about 5 wt. % TPE. In other embodiments, the formulation for the high modulus material may range from about 20 wt. % TPE to about 5 wt. % TPE. Increasing the percentage by weight of polypropylene in the compound relative to percentage by weight of TPE is believed to increase the kink resistance of the hose 10, but reduce the flexibility. The high modulus material from which the strips 14, 16, 18, 20 are formed may include from 0.5 wt. % to 2.0 wt. % of pigments to provide a color and additives like ultraviolet stabilizers, heat stabilizers, and lubricants.

High modulus material formulations suitable for constructing the reinforcement strips 14, 16, 18, 20 may comprise a compound of a polypropylene homopolymer and a TPE selected from the ENGAGE® family of ethylene-butene copolymers commercially available from The Dow Chemical Company (Midland, Mich.). In one embodiment, these materials are combined in a ratio of about 20 wt. % TPE to about 80 wt. % polypropylene homopolymer. A particularly useful polymer compound for the high modulus material of reinforcement strip 14 includes ENGAGE® ENR™ 7256 ethylene-butene copolymer and a polypropylene homopolymer, which may be combined in a ratio of about 20 wt. % TPE to about 80 wt. % polypropylene homopolymer.

ENGAGE® ENR™ 7256 is characterized by a density of 0.885 grams per cubic centimeter (ASTM D792), a melt mass flow rate of 2.0 grams per ten minutes (190° C., ASTM D1238), and a tensile strength with a yield of 11.2 MPa when molded and tested in accordance with ASTM D638. A representative polypropylene homopolymer for use in the high modulus material of reinforcement strip 14 comprises H110-02N polypropylene that is commercially available from The Dow Chemical Company (Midland, Mich.). H110-02N polypropylene is characterized by a density of 0.900 grams per cubic centimeter (ASTM D792), a melt mass flow rate of 2.0 grams per 10 minutes (230° C.; ASTM D1238), and a tensile strength with a yield of 35.2 MPa when molded and tested in accordance with ASTM D638.

The high modulus material of reinforcement strips 14, 16, 18, 20 may be selected with a composition that exhibits a minimum initial modulus of about 5,000 pounds per square inch (psi) and a minimum tensile strength of about 1,000 psi, or greater. The tensile strength represents the stress at the inflection point or maximum on the engineering stress-strain curve, which corresponds to the maximum stress that can be sustained by a structure in tension. In one embodiment, the high modulus material of reinforcement strip 14 is characterized by an initial modulus of about 40,000 psi or greater and a tensile strength of about 1,600 psi or greater. Although not wishing to be limited by theory, the relatively high initial modulus of the high modulus material of reinforcement strips 14, 16, 18, 20 is believed to impart appreciable kink resistance to the hose 10 and the minimum tensile strength of the high modulus material of reinforcement strips 14, 16, 18, 20 is believed to impart appreciable burst strength to the hose 10.

The outer cover 12 operates to protect the inner tubular member 24 and the yarn layer 22 from the environment of the hose 10 when deployed for use in the field. The outer cover 12 also provides adhesion to the inner tubular member 24 that will not allow the yarn layer 22 to move around. The yarn layer 22 includes windows between the constituent filaments that permit the material of the outer cover 12 to contact the inner tubular member 24 and provide a cohesive hose construction.

The outer cover 12 is composed of a flexible material characterized by a low initial modulus so that the hose 10 is not excessively stiff. In particular, the low modulus material constituting the outer cover 12 is significantly more flexible (i.e., has a lower initial modulus) than the high modulus material constituting the reinforcement strip 14. In one aspect, the low modulus material constituting the outer cover 12 exhibits an initial modulus in a range from about 200 psi to about 1,000 psi. In one embodiment, the initial modulus of the low modulus material is about 550 psi. The minimum tensile strength for the low modulus material may be about 800 psi, or greater. However, the minimum tensile strength may be as low as about 540 psi.

The formulation for the low modulus material constituting the outer cover 12 may comprise a mixture of an olefin block copolymer (OBC) and a styrene/ethylene-butylene/styrene-based (SEBS) thermoplastic elastomer (TPE). A particular olefin block copolymer for use in forming outer cover 12 is Infuse D9107 commercially available from The Dow Chemical Company (Midland, Mich.), which is characterized by a density of 0.866 grams per cubic centimeter (ASTM D792) and a melt mass flow rate of 1.0 grams per ten minutes (190° C./2.16 kg, ASTM D1238). In one embodiment, the low modulus material constituting the outer cover 12 may be composed of a 50 wt. %:50 wt. % mixture of OBC and SEBS-based TPE. The low modulus material from which the outer cover 12 is formed may include from 0.5 wt. % to 2.0 wt. % of pigments to provide a color and additives like ultraviolet stabilizers, heat stabilizers, and lubricants. In one embodiment, the SEBS used in the low modulus material may be a compound containing 80 parts to 200 parts of oil and homopolymer, as well as fillers and additives.

The combination of a low modulus material for the outer cover 12 and a high modulus material for the reinforcement strips 14, 16, 18, 20 is selected to construct a hose 10 that, in comparison with conventional hose constructions, exhibits acceptable flexibility, kink resistance, and crush resistance under zero- and low-fluid pressure conditions without sacrificing strength that resists bursting. In certain embodiments of the invention, the materials for the outer cover 12 and reinforcement strips 14, 16, 18, 20 may be selected to operate under internal working fluid pressures ranging from about 15 psi to about 500 psi.

The inner tubular member 24 is also formed from a low modulus material that is chemically resistant, chemically inert, and resistant to permeation by the fluid conveyed through the lumen 28. The inner tubular member 24 lends strength to the hose 10 for increasing the burst pressure and operates in this regard with the yarn layer 22 and reinforcement strips 14, 16, 18, 20 to provide a relative high burst pressure. The inner tubular member 24 is relatively flexible with a low initial modulus so that the hose 10 is not overly stiff and rigid.

The formulation for the material forming the inner tubular member 24 may comprise a compound of a polypropylene homopolymer and an olefin block copolymer. In particular, the polypropylene homopolymer may be H110-02N polypropylene and the olefin block copolymer may be Infuse D9107 blended in a ratio of about 90 wt. % olefin block copolymer to about 10 wt. % polypropylene homopolymer. The low modulus material from which the inner tubular member 24 is formed may include from 0.5 wt. % to 2.0 wt. % of pigments to provide a color and additives like ultraviolet stabilizers, heat stabilizers, and lubricants.

In one aspect, the low modulus material constituting the inner tubular member 24 exhibits an initial modulus in a range between about 200 psi and about 5,000 psi. In one embodiment, the initial modulus of the low modulus material is about 4000 psi. The minimum tensile strength for the low modulus material may be about 800 psi, or greater. However, the minimum tensile strength may be as low as about 875 psi.

The hose 10 may be manufactured or fabricated using extrusion techniques known to a person having ordinary skill in the art. In one embodiment, the inner tubular member 24 is formed as an extrusion and the yarn layer 22 is applied about the exterior of the inner tubular member 24. A portion of the outer cover 12 is applied, the reinforcement strips 14, 16, 18, 20 are applied in a die spinning process, and then the remainder of the outer cover 12 is applied.

Hose 10 may be adapted for use in a wide variety of industrial or household applications. One commercial application for hose 10 is a garden or water hose for household or industrial use. Another commercial application for hose 10 is a drop hose mainly used for the transfer of various fluids including, but not limited to, gasoline, petroleum-based products, chemicals, petrochemicals, and fluid food products. Hose 10 may be also used to make pneumatic hoses for use in conjunction with pneumatic tools and other fluid actuated devices.

References herein to terms such as “inner” or “interior” and “outer” or “exterior” refer, respectively, to directions toward and away from the center of the referenced element, and the terms “radial” and “axial” refer, respectively, to directions perpendicular and parallel to the longitudinal central axis of the referenced element are made by way of example, and not by way of limitation, to establish a frame of reference. It is understood that various other reference frames may be employed for describing the invention.

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants' general inventive concept.

What is claimed is:

1. A hose comprising:
an inner tubular member;
an outer tubular member;
a yarn layer disposed between the inner and outer tubular members; and
a plurality of reinforcement strips within the outer tubular member and helically wound with a pitch about the lumen of the tubular member,
wherein the outer tubular member is composed of a first compound containing an olefin block copolymer and a styrene/ethylene-butylene/styrene-based thermoplastic elastomer, and the reinforcement strips are composed of a second compound containing a thermoplastic elastomer and a polypropylene homopolymer.

2. The hose of claim 1 wherein the yarn layer is composed of polyester, and the yarn layer includes nine yarns wrapped in a rotational sense about the inner tubular member and nine yarns wrapped in an opposite rotational sense about the inner tubular member.

3. The hose of claim 1 wherein the first compound includes the styrene/ethylene-butylene/styrene-based thermoplastic elastomer and the olefin block copolymer in a ratio of about 50 wt. % to about 50 wt. %

4. The hose of claim 3 wherein the inner tubular member contains a third compound composed of a polypropylene homopolymer and an olefin block copolymer.

5. The hose of claim 4 wherein the third compound includes the polypropylene homopolymer and the olefin block copolymer in a ratio of about 10 wt. % to about 90 wt. %

6. The hose of claim 5 wherein the second compound includes the thermoplastic elastomer and the polypropylene homopolymer in a ratio of about 20 wt. % to about 80 wt. %.

7. The hose of claim 3 wherein the second compound includes the thermoplastic elastomer and the polypropylene homopolymer in a ratio of about 20 wt. % to about 80 wt. %.

8. The hose of claim 1 wherein the first compound has an initial modulus that is smaller than an initial modulus of the second compound.

9. The hose of claim 8 wherein the first compound has an initial modulus of 1,000 psi or less, and the second compound has an initial modulus of 5,000 psi or larger.

10. The hose of claim 1 wherein the inner tubular member contains a third compound composed of a polypropylene homopolymer and an olefin block copolymer.

11. The hose of claim 10 wherein the third compound includes the polypropylene homopolymer and the olefin block copolymer in a ratio of about 10 wt. % to about 90 wt. %.

12. The hose of claim 1 wherein the thermoplastic elastomer in the second compound is an ethylene-butene copolymer.

13. The hose of claim 1 wherein the reinforcement strips are four in number.

14. The hose of claim 13 wherein the outer tubular member is approximately symmetrical about a longitudinal axis, and the four reinforcement strips are helically wound with approximately equal pitches about the longitudinal axis.
